(19) United States
(12) Patent Application Publication
(10) Pub. No.: US 2024/0359131 A1
(43) Pub. Date: Oct. 31, 2024

(54) CARBON DIOXIDE CAPTURE WITH CONTACTOR HAVING FLUIDICALLY-ISOLATED, THERMALLY-CONNECTED, PARALLEL FLUID DOMAINS

(71) Applicant: GE Infrastructure Technology LLC, Greenville, SC (US)

(72) Inventors: David Roger Moore, Rexford, NY (US); Vitali Victor Lissianski, Schenectady, NY (US); Mark Daniel Doherty, Niskayuna, NY (US); Daniel Jason Erno, Clifton Park, NY (US); Anil Raj Duggal, Niskayuna, NY (US)

(73) Assignee: GE Infrastructure Technology LLC, Greenville, SC (US)

(21) Appl. No.: 18/770,138

(22) Filed: Jul. 11, 2024

Related U.S. Application Data
(63) Continuation of application No. 17/168,792, filed on Feb. 5, 2021, now Pat. No. 12,059,648.

(51) Int. Cl. B01D 53/14; B01D 53/62; C01B 32/50

(52) U.S. Cl. CPC B01D 53/1475; B01D 53/1406; B01D 53/1418; B01D 53/62; C01B 32/50; B01D 2257/504; C01B 2210/0018

(57) ABSTRACT

A carbon dioxide (CO₂) capture system and method for removing CO₂ from an inlet gas including a first fluid stream inlet providing for the flow of a first fluid stream, such as an inlet gas containing CO₂, and a second fluid stream inlet providing for the flow of a second fluid stream, such as steam, an outlet providing for the flow of a CO₂ depleted stream from the CO₂ capture system, an outlet providing for the flow of a CO₂ stream from the CO₂ capture system and a concentrator in fluid communication with the first fluid stream. The system further including a first contactor and a second contactor. Each of the first contactor and the second contactor defining therein a first fluidically-isolated, sorbent-integrated, fluid domain for flow of the first fluid stream and CO₂ adsorption and a second fluidically-isolated fluid domain for flow of the second fluid stream to assist in desorption.

### CROSS REFERENCE TO RELATED APPLICATIONS

The present patent application is a continuation of U.S. application Ser. No. 17/168,792, filed Feb. 5, 2021, which is hereby incorporated by reference in its entirety to provide continuity of disclosure. The present patent application is also related to concurrently filed, co-pending, and commonly assigned U.S. patent application Ser. No. ______, entitled CARBON DIOXIDE CAPTURE WITH SYSTEM OF CONTACTORS EACH HAVING FLUIDICALLY-ISOLATED, THERMALLY-CONNECTED, PARALLEL FLUID DOMAINS (Attorney Docket No.: 602841-US-8), the disclosure of which is incorporated herein by reference.

### BACKGROUND

Embodiments of the present disclosure relate to a carbon dioxide (CO₂) capture system and method of capturing CO₂, and more particularly, to a CO₂ capture system including at least one contactor to extract CO₂ from air using sorbents and thermally-enhanced recovery efforts.

Global energy demands are met largely through the combustion of fossil fuels, which produces greater than 35 gigatons of CO₂ annually. Direct air capture is a carbon capture process that could address both current and legacy CO₂ emissions. Although current direct air capture solutions show promise, system costs are prohibitive due to challenges that include efficient, high capacity capture of dilute concentrations (˜400 ppmv) of CO₂ in the atmosphere, material lifecycle and stability, and effects of pressure drop across the contactor on system economics and energy consumption. The National Academies of Sciences, Engineering, and Medicine Negative Emissions Technologies estimates the cost of CO₂ capture using existing technologies to be in the range of $141-$265/ton using liquid solvents and $88-$228/ton using solid sorbents. These costs are too high for technologies to be commercially viable.

It may therefore be desirable to develop novel CO₂ capture system capable of capturing CO₂ in the air and method of capturing CO₂ in the air that advantageously require low energy and can operate at a costs that is commercially viable, have a relatively small footprint and can be deployed at locations with higher wind speeds, such as rooftops of commercial buildings, where state of the art technologies, cannot be deployed.

### BRIEF DESCRIPTION

In accordance with aspects of the present disclosure, a novel CO₂ capture system is presented. The novel CO₂ capture system includes a first fluid stream inlet providing for the flow of a first fluid stream into the CO₂ capture system, a second fluid stream inlet providing for the flow of a second fluid stream into the CO₂ capture system, an outlet providing for the flow of a CO₂ depleted stream from the CO₂ capture system, an outlet providing for the flow of a CO₂ stream from the CO₂ capture system and at least one concentrator in fluid communication with the first fluid stream. The first fluid stream comprising an inlet gas. The second fluid stream comprising a gas having a temperature greater than the inlet gas.

In accordance with another aspect of the present disclosure, a novel CO₂ capture system is presented. The novel CO₂ capture system includes a first fluid stream inlet providing for the flow of a first fluid stream into the CO₂ capture system and a second fluid stream inlet providing for the flow of a second fluid stream into the CO₂ capture system, a first contactor in fluid communication with the first fluid stream inlet and the second fluid stream inlet and a second contactor in fluid communication with the first fluid stream inlet and the second fluid stream inlet. The first fluid stream comprising an inlet gas. The second fluid stream comprising a gas having a temperature greater than the inlet gas. Each of the first contactor and the second contactor defining therein a first fluidically-isolated, sorbent-integrated, fluid domain for flow of the first fluid stream and CO₂ adsorption and a second fluidically-isolated fluid domain a second fluidically-isolated fluid domain for flow of the second fluid stream, wherein the second fluidically-isolated fluid domain is in thermal communication with the first fluidically-isolated, sorbent-integrated, fluid domain.

In accordance with yet another aspect of the present disclosure, a method for removing carbon dioxide (CO₂) from an inlet gas in a CO₂ capture system is presented. The novel method includes inputting into the CO₂ capture system a first fluid stream via a first fluid stream inlet, inputting into the CO₂ capture system a second fluid stream via a second fluid stream inlet, and providing an output of a CO₂ depleted stream and a CO₂ stream from the CO₂ capture system. The first fluid stream comprising a CO₂ containing inlet gas. The first fluid stream inlet comprising a concentrator in fluid communication with the first fluid stream. The second fluid stream comprising a gas having a temperature greater than the CO₂ containing inlet gas.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a first cycle in an exemplary CO₂ capture system for recovering CO₂ from an inlet fluid, in accordance with one embodiment of the present disclosure;

FIG. 2 is a schematic view of a second cycle in the exemplary CO₂ capture system of FIG. 1, in accordance with one embodiment of the present disclosure;

FIG. 3 is a schematic view of a first cycle in another embodiment of a CO₂ capture system for recovering CO₂ from an inlet fluid, in accordance with one embodiment of the present disclosure; and

FIG. 4 is a schematic view of a second cycle in the CO₂ capture system of FIG. 3, in accordance with one embodiment of the present disclosure.

Repeat use of reference characters in the present specification and drawings is intended to represent the same or analogous features or elements of the embodiment shown.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “fluid” includes any medium or material that flows, including, but not limited to, air, gas, liquid, and steam.

As will be described in detail hereinafter, various embodiments of a novel CO₂ capture system are presented. The novel CO₂ capture system includes at least one contactor for the extraction of CO₂ from a surrounding fluid, such as ambient air, using sorbents and thermally-enhanced recovery efforts. The disclosed system solves the problem of high CO₂ extraction costs by integrating a sorbent with a contactor and by utilizing an air concentrator. The high surface area sorbent-integrated contactor, low pressure drop across the contactor, and air concentrator are key contributors to the system performance. The contactor features a design that contains at least two fluidically-isolated, independent, massively parallel fluid domains: a) sorbent-integrated fluid domain that provides for flow of ambient air and CO₂ adsorption from the ambient air flow; b) a second fluid domain to promote desorption via transfer of sensible heat to the sorbent-integrated fluid domain; and c) an optional third fluid domain that can be sorbent integrated or used to promote desorption.

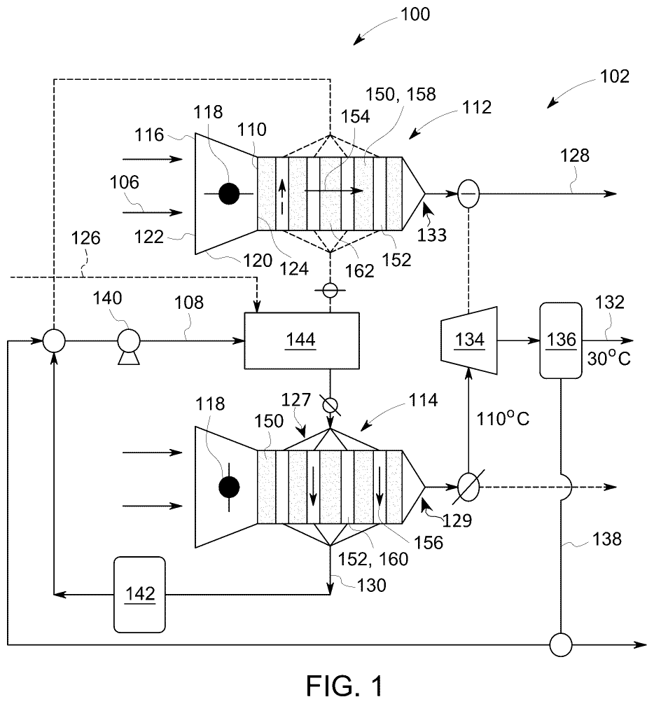

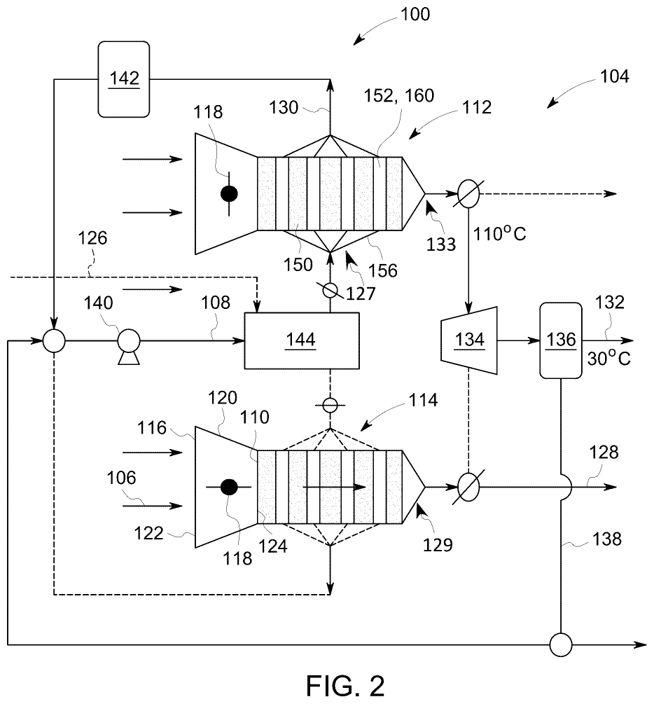

Referring now to FIGS. 1 and 2 illustrated is an exemplary embodiment of a CO₂ capture system 100 that functions to capture CO₂. The CO₂ capture system 100 is configured to remove CO₂ from a surrounding environment, such as ambient air or other suitable source of air, or other fluid, that comprises CO₂, utilizing a hot gas stream (e.g., steam) to assist with desorption. The CO₂ capture system 100 of FIGS. 1 and 2 incorporates two contactors (described presently) to provide for continuous operation. FIG. 1 illustrates the CO₂ capture system 100 during operation in a first cycle 102 (Cycle A-described presently). FIG. 2 illustrates the CO₂ capture system 100, during operation in a second cycle 104 (Cycle B-described presently).

With the growing global energy demand that requires the combustion of fossil fuels, it is becoming increasingly important to cheaply and effectively remove CO₂ from ambient air. The CO₂ capture system 100 is configured to remove CO₂ from an inlet gas stream 106, such as ambient air. The CO₂ capture system 100 disclosed herein solves the problem of high CO₂ extraction costs by integrating a sorbent with at least one, and preferably two, contactors (described presently) and utilizing an air concentrator to increase air flow through contactors. A high surface area, sorbent-integrated contactor and low pressure drop across the contactor are key contributors to the performance of the CO₂ capture system 100. The CO₂ capture system 100 provides effective thermal integration by utilizing a hot gas stream 108 during desorption, such as low pressure steam, to assist in desorption via transfer of heat to a fluidically-isolated, sorbent-integrated, fluid domain (described presently) defined within the CO₂ capture system 100.

As illustrated in FIGS. 1 and 2, the CO₂ capture system 100 comprises a first fluid stream, and more particularly, the inlet gas stream 106, that enters the CO₂ capture system 100 at an inlet 110 of a respective contactor during the adsorption phase of operation. In an embodiment, the inlet gas 106 includes ambient air including CO₂. For example, in an embodiment, the inlet gas 106 includes direct air capture, such as an inlet gas having approximately 412 ppmv CO₂. In an alternate embodiment, the inlet gas 106 includes post-combustion gas capture, such as a post combustion gas having approximately 6-15% CO₂. In an embodiment, the inlet gas stream 106 may be cooled first in order to help reduce the volume of the gas, and therefore, to reduce the size and weight of the CO₂ capture system 100. During operation in the first cycle 102 (FIG. 1), the inlet gas stream 106 is fed into a first contactor 112, operating in an adsorption mode. During operation in a second cycle 104 (FIG. 2), the inlet gas stream 106 is fed into a second contactor 114, operating in an adsorption mode. In an alternate embodiment, the CO₂ capture system 100 may comprise any number (n) of contactors capable of operation in alternating adsorption and desorption modes. The number of included contactors will depend on the concentration of CO₂ in the inlet gas stream 106, the volume of the inlet gas stream 106, the desire for continuous operation, and the like. Accordingly, embodiments including a first contactor and at least one additional contactor are anticipated. Embodiments illustrating the inclusion of a first and second contactor 112, 114 are illustrated herein for ease in description.

In the illustrated embodiment of FIGS. 1 and 2, a concentrator 116 enables passive and/or active capture of ambient CO₂ from the wind. As the inlet gas stream 106 is fed into the contactor 112 or 114 operating in an adsorption mode, it passes through the concentrator 116 prior to reaching the respective contactor 112, 114. The concentrator 116 increases static wind pressure above pressure drop across the contactor 112, 114, thus relying on wind pressure to move air through the contactor 112, 114. Each of the first and second contactors 112, 114, includes a gate 118 that allows the inlet gas stream 106 to pass through the respective contactor 112, 114 during the CO₂ adsorption cycle and blocks air flow through the respective contactor 112, 114 when operating in a CO₂ desorption cycle. FIG. 1 illustrates gate 118 disposed proximate to the contactor 112 in an open position to allow for the passage therethrough of the inlet gas 106, and gate 118 disposed proximate to the contactor 114 in a closed position to block the inflow of the inlet gas 106. FIG. 2 illustrates gate 118 disposed proximate to the contactor 112 in a closed position to block the inflow of the inlet gas 106, and gate 118 disposed proximate to the contactor 114 in an open position to allow for the passage therethrough of the inlet gas 106.

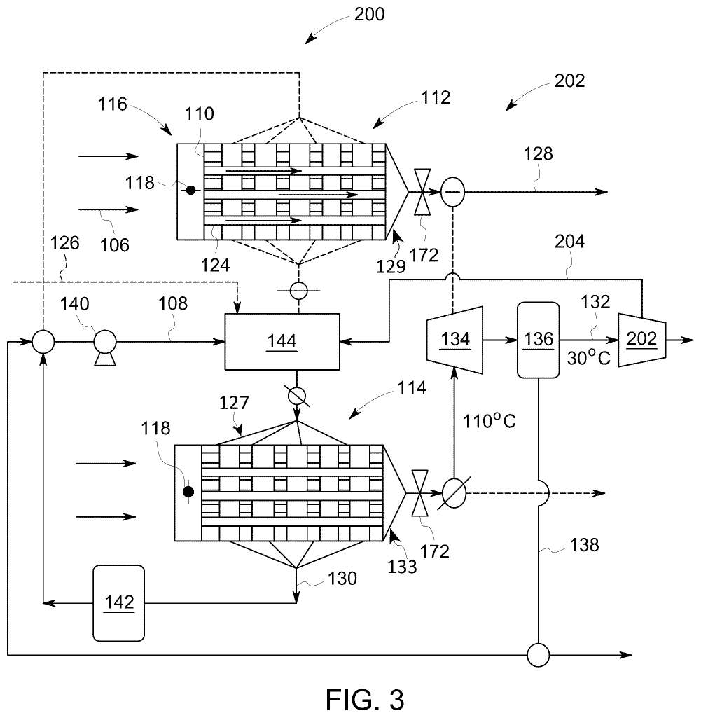

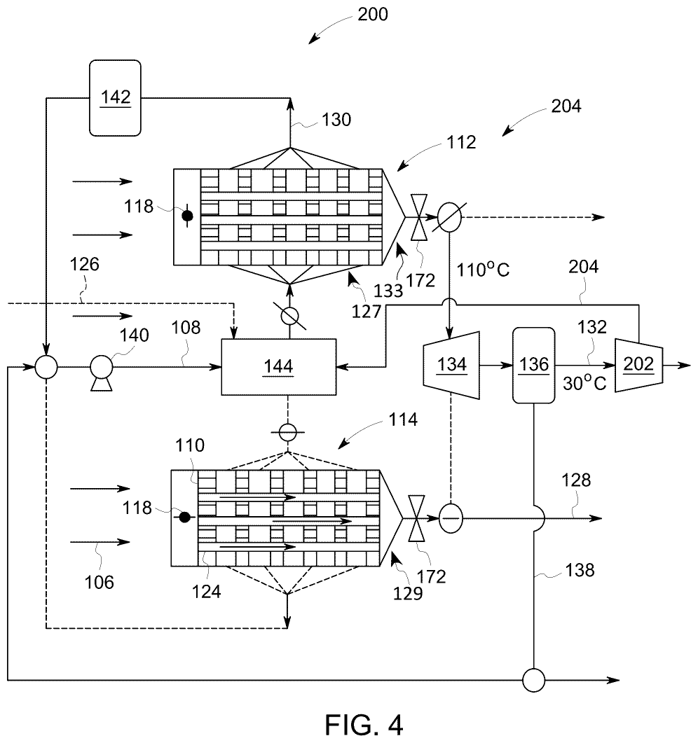

Referring briefly to FIGS. 3 and 4, illustrated is a second preferred embodiment, of a CO₂ capture system 200. Unless otherwise indicated, the second preferred embodiment of the CO₂ capture system 200 includes the same components identified during the description of the first preferred embodiment shown in FIGS. 1 and 2. In contrast to the first preferred embodiment, the second preferred embodiment does not include a concentrator for the input of the inlet gas 106. Instead, the second preferred embodiment the inlet gas stream 106 passes directly into the respective contactor 112, 114, such as by the use of a fan 172 to drive air through the contactor 112, 114. It is noted in the second preferred embodiment, a similar type gate structure 118 is associated therewith the inlet 110 of the respective contactor 112, 114, and operable to permit or block the input of the inlet gas 106.

Returning again to FIGS. 1 and 2, the concentrator 116 may be a passive airflow concentrator, meaning no added energy is required for the concentration of the inlet gas stream 106, or an active airflow concentrator, meaning energy is provided to aid with air movement. In the illustrated embodiment of FIGS. 1 and 2, the airflow concentrator 116 is a passive cone-shaped concentrator 120 that does not require the use of additional energy to concentrate the airflow toward the respective contactor 112, 114. The cone-shaped concentrator 120 may be generally shaped to include a diverging-converging geometry and disposed upstream and proximate to the inlet 110 of the respective contactor 112, 114. The cone-shaped concentrator 120 increases wind speed and corresponding wind static pressure at the concentrator outlet. More specifically, air flow such as inlet gas stream 106, is accelerated from a larger opening at an inlet 122 of the concentrator 116 to a smaller opening at an outlet 124 of the concentrator 116. As the inlet gas stream 106 enters the diverging portion, and as the area decreases in the diverging portion as it moves toward the converging portion proximate to the contactor 112, 114, the inlet gas stream 106 velocity increases. Since wind pressure ΔP is a strong function of wind speed, ΔP=0.5×ρ×V² (ρ is air density and Vis air velocity), flow acceleration increases wind pressure. The dimensions of the concentrator 116 are designed to create wind pressure at the inlet 110 of the contactor 112, 114 that exceeds pressure drop across the contactor 112, 114. The pressure difference between the wind pressure and contactor pressure drop forces air flow through the respective contactor 112, 114 operating in an adsorption mode. A portion of air collected at the inlet 110 of the contactor 112, 114 flows through the contactor. As previously eluded to, in an alternate embodiment, a passive airflow concentrator, such as a fan powered by the movement of the air may be utilized, upstream or downstream of the contactor.

The hot gas stream 108 originates from a source of heated fluid, such as, but not limited to, a boiler, a gas turbine or internal combustion engine that can provide exhaust gases after natural gas, or some other combustive fuel, is ignited in the engine. Heat from the hot gas stream 108 assists in desorption via transfer of heat to a fluidically-isolated, sorbent-integrated, fluid domain (described presently) defined within the CO₂ capture system 100. In an embodiment, the hot gas stream 108, is created by producing steam in a boiler 144. In the illustrated embodiment, energy input to the boiler 144, as illustrated by arrowed line 126, is provided at by one or more of a renewable source of energy, stored energy or turbine energy, such as by a combined cycle gas turbine. Steam may be produced at atmospheric or slightly higher pressure. The hot gas stream 108 is input into the respective contactor 112, 114 at a second fluid stream inlet 127. As steam condenses in a second fluid domain (described presently) of the respective contactor 112, 114, heat released during the condensation is transferred to a first fluid domain containing a sorbent (described presently) of the respective contactor 112, 114. Increasing steam pressure allows for an increase in a steam condensation temperature and thus temperature at which sorbent is regenerated. Alternatively, the hot gas stream 108 may be hot air produced by combustion of a fuel (e.g. natural gas) by utilizing an electric heater, or the like. Again, the CO₂ capture system 100 is configured to remove the CO₂ from the inlet gas stream 106, assisted during the desorption mode by the heat from the hot gas stream 108.

As previously stated, the CO₂ capture system 100 includes two contactors, and more particularly the first contactor 112 and the second contactor 114 to provide alternating adsorption and desorption cycles (FIG. 1—Cycle A and FIG. 2—Cycle B) for continuous CO₂ removal from the inlet gas stream 106. More particularly, in the described embodiment, during Cycle A, as best illustrated in FIG. 1, the first contactor 112 serves as an adsorption unit and the second contactor 114 serves as a desorption unit with the inlet gas stream 106 directed through the first contactor 112 and the hot gas stream 108 directed through the second contactor 114. In an embodiment, the contactor acting in the desorption mode of operation experiences a medium-temperature (110° C.) desorption cycle to release CO₂ and regenerate a sorbent (described presently) within the contactor. As stated, for continuous CO₂ removal, in an embodiment, when the first contactor 112, and more particularly, when the adsorption materials are spent within the first contactor 112, and thus approaches its full sorbent capacity, the air flow, and more particularly, the inlet gas stream 106, through the first contactor 112 is shut down via the gate 118 and directed to the second contactor 114. The first contactor 112 then acts as a desorption unit, as best illustrated in FIG. 2, and the second contactor 114 acts as an absorption unit. The cyclical operation of the first contactor 112 and second contactor 114 in adsorption and desorption states of operation or modes is continuous.

During operation, the inlet gas stream 106 passes through the gate 118 in the concentrator 116 that allows air to pass through the respective contactor 112, 114 operating in the CO₂ adsorption mode and blocks air flow during a CO₂ desorption cycle. The inlet gas stream 106 exits the adsorption contactor 112, 114 as a CO₂ depleted stream 128, and can be vented via an outlet (not shown) to atmosphere or further treated or recycled for energy recovery.

During Cycle A operation, as shown in FIG. 1, when the first contactor 112 is acting as an adsorption unit and the second contactor 114 is acting as a desorption unit, the CO₂ depleted stream 128 is vented from the first contactor 112 and a CO₂ stream 132 is removed from the second contactor 114 using a vacuum pump 134, and continues on for further treatment, such as compression, sequestration, and the like. The CO₂ stream 132 may contain moisture adsorbed by the sorbent along with CO₂ during the adsorption cycle. This moisture will be released from the sorbent during the desorption cycle. In an embodiment, the CO₂ stream 132 is cooled via an air cooler 136 that may result in condensation of excess moisture 138 that is vented away from the outlet of the CO₂ stream 132. At least a portion of the excess moisture 138 may be used as system makeup water and is recirculated via a pump 140 for production of steam in the boiler 144.

During Cycle B operation, as shown in FIG. 2, when the first contactor 112 is acting as a desorption unit and the second contactor 114 is acting as an adsorption unit, the CO₂ depleted stream 128 is vented from the second contactor 114 and a CO₂ stream 132 is removed from the first contactor 112 using the vacuum pump 134, and continues on for further treatment, such as compression, sequestration, and the like. Similar to the previous, the CO₂ stream 132 may include moisture and is cooled via the air cooler 136, and excess moisture 138 vented away from the outlet of the CO₂ stream 132.

Referring again briefly to FIGS. 3 and 4, as previously described with regard to FIGS. 1 and 2, the CO₂ stream 132 upon exiting the respective contactor 112, 114, may include further treatment, such as compression, sequestration, and the like. Accordingly, as illustrated in FIGS. 3 and 4, the second preferred embodiment includes a compressor 202, thus providing for heat integration via compression from the CO₂ stream 132 back to the boiler 144, as shown at 204, to aid with steam production. It should be understood that the inclusion of a compressor, such as compressor 202, in the embodiment of FIGS. 1 and 2 is anticipated by this disclosure.

During operation the hot gas stream 108, and more particularly low-pressure steam, passes through the second contactor 114 (Cycle A) or the first contactor 112 (Cycle to assist in desorption via the transfer of heat to a first fluidically-isolated, sorbent-integrated, fluid domain in the respective contactor (described presently), thus providing the heat required for CO₂ desorption and sorbent regeneration. The hot gas stream 108 is recirculated through the CO₂ capture system 100 via a pump 140. In an embodiment, the excess moisture removed from the CO₂ stream 132 by the air cooler 136, may be routed to the hot gas stream 108.

As previously stated, each of the contactors 112, 114 features two fluidically-isolated fluid domains. Alternatively, a unique, multi-furcating design can be employed to increase contactor surface area. The multi-furcating design includes two fluidically-isolated, independent, massively parallel fluid domains. The contactors 112, 114 with multi-furcating design may be formed using the unique capabilities of additive manufacturing to enable the fabrication of, and sorbent integration, into structures with larger surface/weight ratios and much lower pressure drops than conventional contactors. The parallel fluid domains of each of the contactors 112, 114 include: (i) a first fluidically-isolated, sorbent-integrated, fluid domain 150; and (ii) a second fluidically-isolated fluid domain 152, each defining a fluid flow path, or channel, for the flow of a fluid. The term “fluidically-isolated” as used herein is intended to note isolation of the fluid through each domain from fluid in another domain, so as to prevent mixing of the fluids or direct contact therebetween. During an adsorption stage of operation, the first fluidically-isolated, sorbent-integrated, fluid domain 150 provides for flow of a first fluid stream 154, and more particularly the inlet gas stream 106, and CO₂ adsorption. The second fluidically-isolated fluid domain 152 provides for flow of a second fluid stream 156, and more particularly the hot gas stream 108, to assist in desorption, during a desorption stage of operation, via transfer of heat to the first fluidically-isolated, sorbent-integrated, fluid domain 150.

The first fluid domain 150 defines therein a sorbent-integrated channel, or flow path, 158 for flow of the first fluid stream 154, and more particularly the inlet gas stream 106, and CO₂ adsorption. The second fluid domain 152 defines a second fluid stream channel, or flow path, and more particularly, a warming channel 160 to promote desorption via transfer of sensible heat to the sorbent-integrated channel 158, and more particularly, the first fluid domain 150. Also stated, the second fluidically-isolated fluid domain 152 is in thermal communication with the first fluidically-isolated, sorbent-integrated, fluid domain 150.

During operation, the first fluid stream 154 is first directed through the sorbent-integrated channel 158, and more particularly, the first fluid domain 150. Here, CO₂ is adsorbed into a sorbent material 162 until the sorbent material 162 reaches its full CO₂ adsorption capacity. In an embodiment, the sorbent material 162 may comprise metal-organic frameworks (MOF); covalent organic frameworks (COF), such as COF-A1; zeolites, such as B-SSZ-13; NH₂ impregnated materials, or the like. In an embodiment, the sorbent-integrated channel 158 may coated with the sorbent material 162, loaded/filled with the sorbent material 162 or formed/made of the sorbent material 162. In an alternate embodiment, the design may include fabrication of the contactor, and more particularly, the first fluid domain 150, from a sorbent itself (e.g., using Binder Jet) and coating some of the contactor channels with a hydrophobic coating, such as, a silica nano-coating, fluorinated silanes and fluoropolymer coatings, to prevent direct contact of sorbent and steam during the regeneration/desorption cycle. As illustrated a CO₂ depleted stream 128 is output from the first fluid domain 150 subsequent to adsorption of the CO₂ from the first fluid stream 154.

Desorption takes place within the contactor 112 in a Cycle B, as illustrated in FIG. 2. During this step, the first fluid stream 154 of inlet gas flowing through the sorbent-integrated channel 158 (FIG. 1) is shut down via the gate 118 and a flow of hot gas, and more particularly the second fluid stream 156, is opened through the warming channel 160 defined by the second fluid domain 152 to provide desorption in the first fluid domain 150. In an embodiment, the second fluid stream 156 has a temperature that is greater than the first fluid stream 154. In a preferred embodiment, the second fluid stream 156 has a temperature greater than 85° C. This drives an appropriate temperature gradient, to provide for the transfer of heat from the second fluid stream 156 to the sorbent material 158 in the first fluid domain 150, initiating desorption. As the sorbent-integrated channel 158 temperature reaches 85° C., the sorbent material 162 releases CO₂, which is pulled from the first fluid domain 150 via a vacuum pump 134.

The CO₂ capture systems 100, 200 of the present disclosure can comprise the at least one contactor, such as the contactor 112, 114, with any well-known sorbent material for the sorbent material 162, such as MOFs, COFs, zeolites, NH₂ impregnated materials, and others. This system can utilize the sorbent material 162 and the contactor 112, 114 at the appropriate partial pressure to absorb the CO₂ from the inlet gas or first fluid stream 154.

The use of alternative cycling of two contactors, and namely the first contactor 112 and the second contactor 114 of FIGS. 1 and 2 and similarly FIGS. 3 and 4, for continuous CO₂ removal where each contactor has massively parallel fluid domains results in low pressure drop, and the separation of the fluids avoids contamination of the CO₂ stream and offers indirect heat exchange. The contactor can be manufactured using additive technology, such as, for instance, binder-jet techniques, or some other means of manufacturing. The described system provides commercial advantages by providing the ability to operate in a wide range of low energy requirements. The technology can be deployed at locations with higher wind speeds, such as rooftops of commercial buildings, where state of the art technologies cannot be deployed. Additional market opportunities may include consumer CO₂, industrial CO₂ capture and desalination.

The CO₂ capture system 100 is shown in FIGS. 1-4 in cutaway to reveal the individual contactors 112, 114 and flow of the fluid streams therethrough. As previously asserted, the CO₂ capture systems 100, 200 can contain a single contactor or any number of contactors, and the number of contactors selected for use in a given system will depend at least in part on the concentration of CO₂ in the inlet gas stream 106, the volume of the inlet gas stream 106, the desire for continuous operation, and the like. Accordingly, embodiments including a first contactor, and at least one additional contactor are anticipated. Embodiments illustrating the inclusion of a first and second contactor are illustrated herein for ease in description.

The various embodiments of the CO₂ capture system as described hereinabove dramatically improves the ability to extract CO₂ from an inlet gas, such as ambient air, utilizing less energy and thus at a lower costs. The use of a concentrator combined with a low pressure drop across the contactor allows the CO₂ capture system to operate in a passive mode thus reducing energy requirements. The integration of a sorbent with a contactor and the transfer of sensible heat to the sorbent channel to assist with desorption, produces a CO₂ stream not contaminated with the fluid used to supply sensible heat. By way of example, the use of a contactor multi-furcating design enabling thermally enhanced recovery of CO₂ in the inlet gas, reduces the cost of operation of the overall system. The use of alternative cycling of at least two contactors for continuous CO₂ removal where each contactor includes the multi-furcating design, and more particularly includes massively parallel channels, results in low pressure drop and offers indirect heat exchange described hereinabove which aids with effective energy transfer in the CO₂ capture system. The various embodiments of the CO₂ capture system, and contactor design, described hereinabove therefore present a fuel-efficient, two-cycle system architecture that generates a CO₂ stream from the inlet gas stream.

The terminology used herein is for the purpose of describing particular embodiments only and is not intended to be limiting of the invention. Ranges disclosed herein are inclusive and combinable of the endpoints and all intermediate values of the ranges. “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described with reference to an exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A contactor, comprising:
a contactor body having a first end with a fluid stream inlet to receive a fluid stream, a second end with a fluid stream outlet to release the fluid stream, and a fluid flow path extending between the first end and the second end that directs the fluid stream received by the fluid stream inlet to the fluid stream outlet for release therefrom; and
a plurality of fluidically-isolated, thermally-connected, parallel fluid domains disposed in the contactor body between the first end and the second end orthogonal to the fluid flow path, wherein the plurality of fluidically-isolated, thermally-connected, parallel fluid domains include:
a plurality of sorbent-integrated fluid channels, each sorbent-integrated fluid channel defining a flow path for the fluid stream passing from the first end to the second end of the contactor body; and
a plurality of heat transfer fluid channels thermally connected to the plurality of sorbent-integrated fluid channels in an alternating arrangement, each heat transfer fluid channel defining a flow path for a heat transfer fluid stream that flows orthogonally to the fluid flow path between the first end and the second end of the contactor body.

2. The contactor of claim 1, wherein each of the plurality of sorbent-integrated fluid channels includes a first walled surface that is configured to receive the fluid stream and a second walled surface opposing the first walled surface that is configured to release a CO₂ depleted fluid stream during an adsorption mode of operation.

3. The contactor of claim 2, wherein both the first walled surface and the second walled surface of each of the plurality of sorbent-integrated fluid channels are configured to release a CO₂ rich fluid stream during a desorption mode of operation.

4. The contactor of claim 1, wherein the contactor body further comprises:
a heat transfer fluid stream inlet in a region between the first end and the second end that is configured to receive the heat transfer fluid stream; and
a heat transfer fluid stream outlet in a region between the first end and the second end opposing the heat transfer fluid stream inlet that is configured to release the heat transfer fluid stream from the contactor body.

5. The contactor of claim 4, wherein each of the plurality of heat transfer fluid channels is configured to receive a portion of the heat transfer fluid stream received by the heat transfer fluid stream inlet and direct the corresponding heat transfer fluid stream to the heat transfer fluid stream outlet for release from the contact body after facilitating heat transfer with adjacent sorbent-integrated fluid channels while the heat transfer fluid stream passes through the channel between the heat transfer fluid stream inlet and the heat transfer fluid stream outlet.

6. The contactor of claim 2, wherein the plurality of sorbent-integrated channels are configured to receive the flow of the fluid stream in the adsorption mode of operation up until reaching a specified CO₂ adsorption capacity.

7. The contactor of claim 6, wherein the plurality of heat transfer fluid channels are configured to receive the heat transfer fluid stream in a desorption mode of operation in response to the plurality of sorbent-integrated fluid channels reaching the specified CO₂ adsorption capacity, the heat transfer fluid stream flowing through the plurality of heat transfer fluid channel to promote desorption via transfer of heat to the plurality of sorbent-integrated fluid channels and regeneration of the sorbent.

8. The contactor of claim 1, wherein the plurality of sorbent-integrated fluid channels comprise one or more of a sorbent material and a sorbent coating.

9. The contactor of claim 8, wherein the sorbent material is selected from the group consisting of metal-organic frameworks (MOF), covalent organic frameworks (COF), zeolites, and NH₂ impregnated materials.

10. The contactor of claim 8, wherein some of the plurality of sorbent-integrated fluid channels comprise a hydrophobic coating selected from the group consisting of a silica nano-coating, a fluorinated silane and a fluoropolymer coating.

11. The contactor of claim 1, wherein the heat transfer fluid stream has a temperature greater than the temperature of the fluid stream.

12. The contactor of claim 1, wherein each of the plurality of fluidically-isolated, thermally-connected, parallel fluid domains is segmented into separate and distinct fluid domains.

13. A contactor, comprising:
a contactor body having a first end with a fluid stream inlet to receive a fluid stream, a second end with a fluid stream outlet to release the fluid stream, and a fluid flow path extending between the first end and the second end that directs the fluid stream received by the fluid stream inlet to the fluid stream outlet for release therefrom; and
a plurality of fluidically-isolated, thermally-connected, parallel fluid domains disposed in the contactor body between the first end and the second end orthogonal to the fluid flow path, wherein the plurality of fluidically-isolated, thermally-connected, parallel fluid domains include:
a plurality of sorbent-integrated fluid channels, each sorbent-integrated fluid channel defining a flow path for the fluid stream passing from the first end to the second end of the contactor body, wherein each of the plurality of sorbent-integrated fluid channels includes a first walled surface that is configured to receive the fluid stream and a second walled surface opposing the first walled surface that is configured to release a CO₂ depleted fluid stream during an adsorption mode of operation, and wherein the second walled surface of each of the plurality of sorbent-integrated fluid channels is configured to release a CO₂ rich fluid stream during a desorption mode of operation; and
a plurality of heat transfer fluid channels thermally connected to the plurality of sorbent-integrated fluid channels in an alternating arrangement, each heat transfer fluid channel defining a flow path for a heat transfer fluid stream that flows orthogonally to the fluid flow path between the first end and the second end of the contactor body.

14. The contactor of claim 13, wherein the contactor body further comprises:
a heat transfer fluid stream inlet in a region between the first end and the second end that is configured to receive the heat transfer fluid stream; and
a heat transfer fluid stream outlet in a region between the first end and the second end opposing the heat transfer fluid stream inlet that is configured to release the heat transfer fluid stream from the contactor body.

15. The contactor of claim 14, wherein each of the plurality of heat transfer fluid channels is configured to receive a portion of the heat transfer fluid stream received by the heat transfer fluid stream inlet and direct the corresponding heat transfer fluid stream to the heat transfer fluid stream outlet for release from the contact body after facilitating heat transfer with adjacent sorbent-integrated fluid channels while the heat transfer fluid stream passes through the channel between the heat transfer fluid stream inlet and the heat transfer fluid stream outlet.

16. The contactor of claim 13, wherein the plurality of sorbent-integrated fluid channels comprise one or more of a sorbent material and a sorbent coating.

17. The contactor of claim 16, wherein the sorbent material is selected from the group consisting of metal-organic frameworks (MOF), covalent organic frameworks (COF), zeolites, and NH₂ impregnated materials.

18. The contactor of claim 16, wherein some of the plurality of sorbent-integrated fluid channels comprise a hydrophobic coating selected from the group consisting of a silica nano-coating, a fluorinated silane and a fluoropolymer coating.

19. The contactor of claim 13, wherein the heat transfer fluid stream has a temperature greater than the temperature of the fluid stream.

20. The contactor of claim 13, wherein each of the plurality of fluidically-isolated, thermally-connected, parallel fluid domains is segmented into separate and distinct fluid domains.
